(19) United States
(12) Patent Application Publication
(10) Pub. No.: US 2002/0131724 A1
(43) Pub. Date: Sep. 19, 2002

(54) High frequency matching method and silicon optical bench employing high frequency matching networks

(75) Inventors: Mark J. Bailey, Lake City, MN (US); David Peter Gaio, Rochester, MN (US); William K. Hogan, Rochester, MN (US); Gerald Wayne Swift, Rolling Hills Estates, CA (US)

Correspondence Address: Leslie J. Payne, IBM Corporation - Dept. 917, 3605 Highway 52 North, Rochester, MN, 55901, US

(73) Assignee: INTERNATIONAL BUSINESS MACHINES CORPORATION

(21) Appl. No.: 09/809,127

(22) Filed: Mar. 15, 2001

(51) Int. Cl. G02B 6/42; G02B 6/30

(52) U.S. Cl. 385/88; 385/49

(57) ABSTRACT

A high frequency matching method and silicon optical bench employing a high frequency matching network are provided. The silicon optical bench comprises a silicon wafer defining a structure for precisely locating an electro-optical component. A predefined metal trace pattern is formed on a surface of the silicon wafer. The predefined metal trace pattern at least one electrical device, such as a thin film resistor, a capacitor or an inductor; or a selected combination of at least one thin film resistor, capacitor or inductor formed at selected predefined locations within the predefined metal trace pattern. The predefined metal trace pattern provides a high frequency impedance matching network for connection with the electro-optical component. The predefined metal trace pattern includes a plurality of selected widths within the predefined metal trace pattern. The widths are selectively provided for changing inductance within the predefined metal trace pattern. The predefined metal trace pattern includes at least one capacitive stub. The capacitive stub is formed within the predefined metal trace pattern for balancing inductance within the predefined metal trace pattern. The thin film resistor is formed at a predefined location within the predefined metal trace pattern by depositing the thin film resistor on a surface of the predefined metal trace pattern. A pair of thin film resistors can be formed at predefined locations within the predefined metal trace pattern adjacent to a pair of traces of the predefined metal trace pattern that connect to electro-optical component, such as a laser.

### CROSS-REFERENCE TO RELATED PATENT APPLICATIONS

The present application is related to the following commonly-assigned and copending U.S. Patent Applications:

United States Serial No. (Attorney Docket No. ROC9-2001-0018-US1) entitled: COMPACT OPTICAL TRANSCEIVERS INCLUDING THERMAL DISTRIBUTING AND ELECTROMAGNETIC SHIELDING SYSTEMS AND METHODS THEREOF;

United States Serial No. (Attorney Docket No. ROC9-2001-0020-US1) entitled: AN OPTICAL FIBER COUPLER AND AN OPTICAL FIBER COUPLER INCORPORATED WITHIN A TRANSCEIVER MODULE;

United States Serial No. (Attorney Docket No. ROC9-2001-0015-US1) entitled: TECHNIQUE AND APPARATUS FOR COMPENSATING FOR VARIABLE LENGTHS OF TERMINATED OPTICAL FIBERS IN CONFINED SPACES;

All of the above-identified U.S. Patent Applications are being filed on the same date concurrently herewith and the subject matter of each of the above-identified U.S. Patent Applications is incorporated herein by reference, as a part hereof.

### FIELD OF THE INVENTION

The present invention relates generally to the data processing field, and more particularly, relates to a high frequency matching method and silicon optical bench employing high frequency matching networks.

### DESCRIPTION OF THE RELATED ART

Silicon optical benches (SiOBs) are used to provide high mechanical precision in locating electro-optical components. The silicon optical bench is made from a wafer of silicon, somewhat similar to those used in silicon device processing.

For example, bulk resistivity silicon typically is used to manufacture silicon optical benches (SiOBs) that are primarily used for the precision location of optical components

For electrical fidelity reasons, a need exists to locate laser modulators and transimpedance amplifiers as close as possible to their respective associated laser and photo-detector. While the conventional SiOB enables precision location of optical components, a need exists for a mechanism to provide improved electrical performance characteristics, particularly for high data rate applications. It is desirable to provide a high frequency matching method and silicon optical bench employing high frequency matching networks.

### SUMMARY OF THE INVENTION

A principal object of the present invention is to provide a high frequency matching method and silicon optical bench employing high frequency matching networks. Other important objects of the present invention are to provide such high frequency matching method and silicon optical bench employing high frequency matching networks substantially without negative effect and that overcome many of the disadvantages of prior art arrangements.

In brief, a high frequency matching method and silicon optical bench employing a high frequency matching network are provided. The silicon optical bench comprises a silicon wafer defining a structure for precisely locating an electro-optical component. A predefined metal trace pattern is formed on a surface of the silicon wafer. The predefined metal trace pattern includes at least one electrical device, such as a thin film resistor, a capacitor or an inductor; or a selected combination of at least one thin film resistor, capacitor or inductor formed at selected predefined locations within the predefined metal trace pattern. The predefined metal trace pattern provides a high frequency impedance matching network for connection with the electro-optical component.

In accordance with features of the invention, the predefined metal trace pattern includes a plurality of selected widths within the predefined metal trace pattern. The widths are selectively provided for changing inductance within the predefined metal trace pattern. The predefined metal trace pattern includes at least one capacitive stub. The capacitive stub is formed within the predefined metal trace pattern for balancing inductance within the predefined metal trace pattern. The thin film resistor is formed at a predefined location within the predefined metal trace pattern by depositing the thin film resistor on a surface of the predefined metal trace pattern. A pair of thin film resistors can be formed at predefined locations within the predefined metal trace pattern adjacent to a pair of traces of the predefined metal trace pattern that connect to electro-optical component, such as a laser.

### BRIEF DESCRIPTION OF THE DRAWINGS

The present invention together with the above and other objects and advantages may best be understood from the following detailed description of the preferred embodiments of the invention illustrated in the drawings, wherein:

FIG. 1 is a perspective view illustrating a silicon optical bench employing a high frequency matching network in accordance with the preferred embodiment; and

FIG. 2 is a top plan view illustrating the silicon optical bench employing the high frequency matching network of FIG. 1 in accordance with the preferred embodiment.

### DETAILED DESCRIPTION OF THE PREFERRED EMBODIMENTS

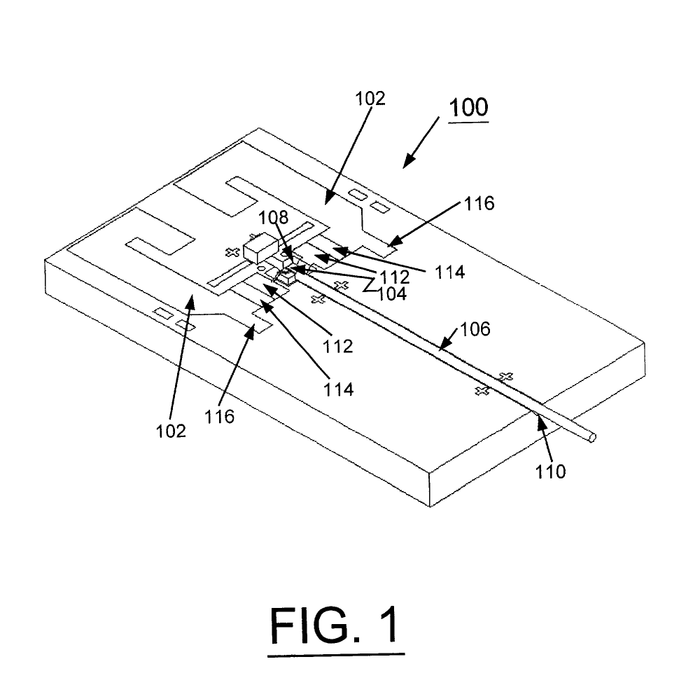

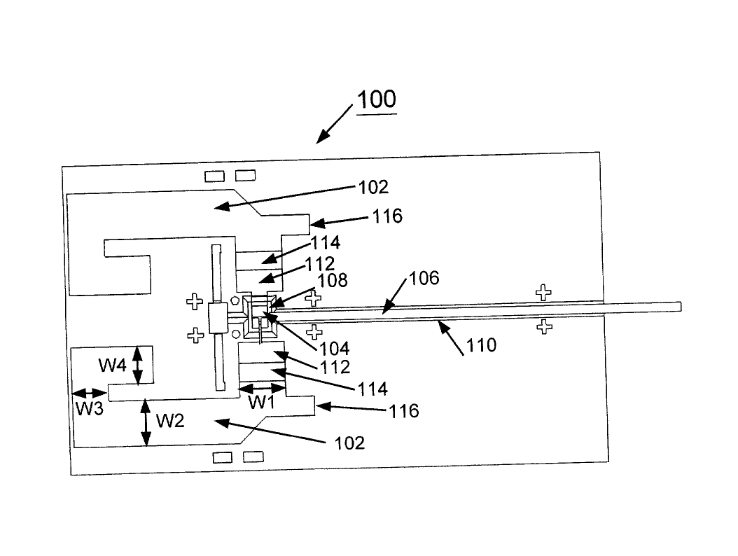

Having reference now to the drawings, in FIGS. 1 and 2, there is shown a silicon optical bench generally designated by the reference character 100 employing a high frequency impedance matching network of the preferred embodiment generally designated by the reference character 102. Silicon optical bench 100 is used to provide high mechanical precision in locating electro-optical components, such as an optical-diode, a laser and the like. Silicon optical bench 100 of the preferred embodiment is a silicon wafer formed of bulk resistivity silicon.

As shown in FIG. 1, silicon optical bench 100 precisely positions a laser 104 and an optical fibre 106. Laser 104 is received in a laser-receiving cavity 108 in alignment with the optical fibre 106 that is received in a slot or groove 110 within the silicon optical bench 100. Laser-receiving cavity 108 and groove 110 are precisely formed within the silicon optical bench 100, for example, by precisely etching the silicon wafer. The crystalline structure of either the silicon wafer or the bulk resistivity silicon wafer achieves high precision in device location when photolithographic techniques are employed to identify and control selected locations of the etch.

Laser 104 is a low impedance device. For example, the 1300 or 1550 edge type lasers have a low impedance, typically 3 to 12 ohms and the laser driver has a higher impedance, such as 25 ohms for a laser driver type manufactured by International Business Machines Corporation.

In accordance with features of the preferred embodiment, high frequency impedance matching network 102 provides an impedance transformation for connection to the laser driver of laser 104. High frequency impedance matching network 102 is formed by a predefined pattern of metal deposited on a top surface of the silicon optical bench 100.

In accordance with features of the preferred embodiment, high frequency impedance matching network 102 is arranged to enable effective electrical performance, particularly for high data rate applications. Laser 104 is connected to a pair of wide traces 112 in the high frequency matching network 102. As shown, a pair of electrical devices 114, such as a pair of thin film resistors 114, a pair of capacitors 114 or a pair of inductors 114 or a combination of resistors, capacitors and inductors, is designed into the impedance matching network 102. The electrical devices 114 are deposited on a top surface of the metal trace pattern 102 at predefined locations within the high metal trace pattern to form the high frequency impedance matching network. In addition to the inclusion of the electrical devices 114, a metal trace pattern 102 of the impedance matching network is designed to balance the amount of capacitance and inductance to arrive at an impedance transformation or matching network. In general, the impedance of a transmission line is the square root of the inductance over the capacitance.

In accordance with features of the preferred embodiment, a pair of capacitive stubs 116 is formed in the metal trace pattern of the high frequency impedance matching network 102. Predetermined trace widths, such as illustrated by arrows labeled W1, W2, W3, and W4, are formed in the metal trace pattern of the impedance matching network 102 to change inductance in the metal trace pattern of the impedance matching network 102.

In one application of the high frequency impedance matching network 102 of the preferred embodiment, a low impedance laser 104 is connected to wide traces 112 of the high frequency impedance matching network 102. The wide traces 112 of the high frequency impedance matching network 102 have an impedance of about 37 ohms, then a transformation is made to 25 ohms for the laser driver having an impedance of 25 ohms with the laser driver type manufactured by International Business Machines Corporation. Capacitive stubs 116 are formed in the metal trace pattern of the high frequency impedance matching network 102 which add capacitance to balance against the inductance of the metal trace pattern of the high frequency impedance matching network.

While the present invention has been described with reference to the details of the embodiments of the invention shown in the drawing, these details are not intended to limit the scope of the invention as claimed in the appended claims.

What is claimed is:

1. A silicon optical bench comprising:
a silicon wafer defining a structure for precisely locating an electro-optical component;
a predefined metal trace pattern formed on a surface of said silicon wafer;
said predefined metal trace pattern including at least one electrical device formed at a predefined location within said predefined metal trace pattern; and
said predefined metal trace pattern providing a high frequency impedance matching network for connection with said electro-optical component.

2. A silicon optical bench as recited in claim 1 wherein said at least one electrical device formed at said predefined location within said predefined metal trace pattern includes one of a thin film resistor, a capacitor or an inductor; or a selected combination of at least one thin film resistor, capacitor or inductor formed at selected predefined locations within said predefined metal trace pattern.

3. A silicon optical bench as recited in claim 1 wherein said at least one electrical device is formed at said predefined location within said predefined metal trace pattern by depositing said electrical device on a surface of said predefined metal trace pattern.

4. A silicon optical bench comprising:
a silicon wafer defining a structure for precisely locating an electro-optical component;
a predefined metal trace pattern formed on a surface of said silicon wafer;
said predefined metal trace pattern including at least one thin film resistor formed at a predefined location within said predefined metal trace pattern; and
said predefined metal trace pattern providing a high frequency impedance matching network for connection with said electro-optical component.

5. A silicon optical bench as recited in claim 4 wherein said predefined metal trace pattern is formed on a surface of said silicon wafer by depositing metallic material for said predefined metal trace pattern on said surface of said silicon wafer.

6. A silicon optical bench as recited in claim 4 wherein said at least one thin film resistor is formed at a predefined location within said predefined metal trace pattern by depositing said thin film resistor on a surface of said predefined metal trace pattern.

7. A silicon optical bench as recited in claim 4 wherein said predefined metal trace pattern includes a plurality of selected widths; said selected widths for changing inductance within said predefined metal trace pattern.

8. A silicon optical bench as recited in claim 4 wherein said predefined metal trace pattern includes at least one capacitive stub.

9. A silicon optical bench as recited in claim 8 wherein said at least one capacitive stub is formed within said predefined metal trace pattern for balancing inductance within said predefined metal trace pattern.

10. A silicon optical bench as recited in claim 4 wherein said silicon wafer defining a structure for precisely locating an electro-optical component includes a cavity for precisely locating a laser.

11. A silicon optical bench as recited in claim 10 wherein said silicon wafer defining a structure for precisely locating an electro-optical component includes a groove in said surface for precisely locating an optical fibre.

12. A silicon optical bench as recited in claim 11 wherein said predefined metal trace pattern providing a high frequency impedance matching network for connection with said laser.

13. A silicon optical bench as recited in claim 11 wherein said cavity for precisely locating said laser and said groove in said surface for precisely locating said optical fibre are formed by etching said silicon wafer.

14. A silicon optical bench as recited in claim 4 wherein said predefined metal trace pattern formed on a surface of said silicon wafer includes a pair of thin film resistors formed at predefined locations within said predefined metal trace pattern, said predefined locations adjacent to a pair of traces of said predefined metal trace pattern connected to said electro-optical component.

15. A high frequency matching method for use with a silicon optical bench defining a structure for precisely locating at least one electro-optical component, said method comprising the steps of:
forming a predefined metal trace pattern on a surface of said silicon optical bench,
forming at least one electrical device at a predefined location within said predefined metal trace pattern; and said predefined metal trace pattern providing a high frequency impedance matching network for connection with the electro-optical component.

16. A high frequency matching method for use with a silicon optical bench as recited in claim 15 wherein said step of forming a predefined metal trace pattern on a surface of said silicon optical bench includes the step of depositing a metallic material on a top surface of said silicon wafer for forming said predefined metal trace pattern.

17. A high frequency matching method for use with a silicon optical bench as recited in claim 15 wherein said step of forming a predefined metal trace pattern on a surface of said silicon optical bench includes the step of forming a plurality of selected widths within said predefined metal trace pattern; said selected widths for changing inductance within said predefined metal trace pattern.

18. A high frequency matching method for use with a silicon optical bench as recited in claim 17 wherein said step of forming a predefined metal trace pattern on a surface of said silicon optical bench includes the step of forming at least one capacitive stub within said predefined metal trace pattern; said at least one capacitive stub being formed within said predefined metal trace pattern for balancing inductance within said predefined metal trace pattern.

19. A high frequency matching method for use with a silicon optical bench as recited in claim 15 wherein said step of forming at least one electrical device at a predefined location within said predefined metal trace pattern includes the step of depositing at least one thin film resistor at a predefined location on a top surface of said predefined metal trace pattern.

20. A high frequency matching method for use with a silicon optical bench as recited in claim 15 wherein said step of forming a predefined metal trace pattern on a surface of said silicon optical bench includes the step of forming a pair of traces of said predefined metal trace pattern for connection to said electro-optical component.

21. A high frequency matching method for use with a silicon optical bench as recited in claim 20 wherein said step of forming at least one thin film resistor at a predefined location within said predefined metal trace pattern includes the step of forming a pair of thin film resistors at predefined locations within said predefined metal trace pattern, said predefined locations being adjacent to said pair of traces within said predefined metal trace pattern connected to said electro-optical component.

22. A high frequency matching method for use with a silicon optical bench as recited in claim 15 wherein said step of forming at least one electrical device at a predefined location within said predefined metal trace pattern includes the step of depositing at least one capacitor at a predefined location on a top surface of said predefined metal trace pattern.

23. A high frequency matching method for use with a silicon optical bench as recited in claim 15 wherein said step of forming at least one electrical device at a predefined location within said predefined metal trace pattern includes the step of depositing at least one inductor at a predefined location on a top surface of said predefined metal trace pattern.
